(19) United States
(12) Patent Application Publication
(10) Pub. No.: US 2007/0123295 A1
(43) Pub. Date: May 31, 2007

(54) Mobile terminal

(75) Inventors: Young-Hwan Kim, Seoul (KR); Kyung-Hwan Lee, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/528,467

(22) Filed: Sep. 28, 2006

(30) Foreign Application Priority Data
Sep. 29, 2005 (KR) 10-0091637-2005

(51) Int. Cl. H04M 1/00

(52) U.S. Cl. 455/550.1

(57) ABSTRACT

A mobile terminal including a main body having a display mounted thereon, and a keypad assembly including at least first and second keypads configured to be received in a stacked state within the main body. Further, the at least first and second keypads are slidably mounted with respect to each other such that when the first keypad is drawn out of the body, the first keypad engages with the second keypad to also draw out the second keypad.

This application claims priority to Korean Patent Application No. 10-2005-0091637 filed on Sep. 29, 2005 in Korea, the entire contents of which is hereby incorporated by reference in its entirety.

### BACKGROUND OF THE INVENTION

1. Field of the Invention

The present invention relates to a mobile terminal.

2. Description of the Related Art

FIG. 1 is an overview of a slide type mobile terminal in accordance with the related art. As shown, the related art slide type terminal includes a terminal body 110 having a battery 104 on one side and a keypad 102 on the other side, and a sliding body 106 that slides open and closed over the keypad 102. Further, the sliding body 106 includes a display 122, function keys 126 and a speaker 124. A printed circuit board (PCB) (not shown) is also disposed between the keypad 102 and the battery 104.

However, because the keypad 102 is mounted on the terminal body 110, the battery 104 is mounted at a rear surface of the terminal body 110, and the PCB is installed between the keypad 102 and the battery 104, the related art sliding-type mobile terminal is relatively thick. The same is true for the bar type terminal shown in FIG. 2.

That is, because the bar type terminal includes a display 132 and a keypad 134 mounted on a front surface of a main body 130, the terminal is relatively thick and also the display 132 is small so as to accommodate the keypad 134.

### SUMMARY OF THE INVENTION

Accordingly, one object of the present invention is to address the above-noted and other objects.

Another object of the present invention is to provide a mobile terminal that includes a stackable keypad inserted within the main body of the terminal and that can be drawn out when needed.

To achieve at least the above objects in whole or in parts, the present invention provides in one aspect a mobile terminal including a main body having a display mounted thereon, and a keypad assembly including at least first and second keypads configured to be received in a stacked state within the main body. Further, the at least first and second keypads are slidably mounted with respect to each other such that when the first keypad is drawn out of the body, the first keypad engages with the second keypad to also draw out the second keypad.

In another aspect, the present invention provides a mobile terminal including a first body, a second body slidably mounted on the first body, and a key pad assembly including at least first and second keypads configured to be received in the second body in a stacked state and drawn out when the first body is slidably opened from the second body such that the first and second key pads are exposed on an upper surface of the first body.

In yet another aspect, the present invention provides a mobile terminal including a first body, a second body slidably mounted on the first body, and a keypad assembly including at least first and second keypads configured to be received between the first and the second body in a stacked state and the first keypad is connected to the first body and the second keypad is connected to the second body such that when the first body is slid open from the second body, the first and second keypads are protracted.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is an overview showing a slide type mobile terminal in accordance with the related art;

FIG. 2 is an overview showing a bar type mobile terminal in accordance with the related art;

FIG. 3 is an overview of a mobile terminal in accordance with one embodiment of the present invention;

FIG. 4 is an overview showing an operational state of the mobile terminal in accordance with one embodiment of the present invention;

FIG. 5A is a sectional view of a keypad assembly included in the mobile terminal in accordance with one embodiment of the present invention;

FIG. 5B is an enlarged view of a portion ‘A’ of FIG. 5;

FIG. 6 is a top view of the keypad assembly in accordance with one embodiment of the present invention;

FIG. 7 is a side view of the keypad assembly in accordance with one embodiment of the present invention;

FIG. 8 is a side view showing a state that the keypad assembly has been drawn out in accordance with one embodiment of the present invention;

FIG. 9 is a sectional view showing another example of the keypad assembly in accordance with one embodiment of the present invention;

FIG. 10 is a sectional view of a mobile terminal in accordance with another embodiment of the present invention; and

FIG. 11 is a sectional view showing an operational state of the mobile terminal in accordance with one embodiment of the present invention.

### DETAILED DESCRIPTION OF THE INVENTION

Reference will now be made in detail to the preferred embodiments of the present invention, examples of which are illustrated in the accompanying drawings.

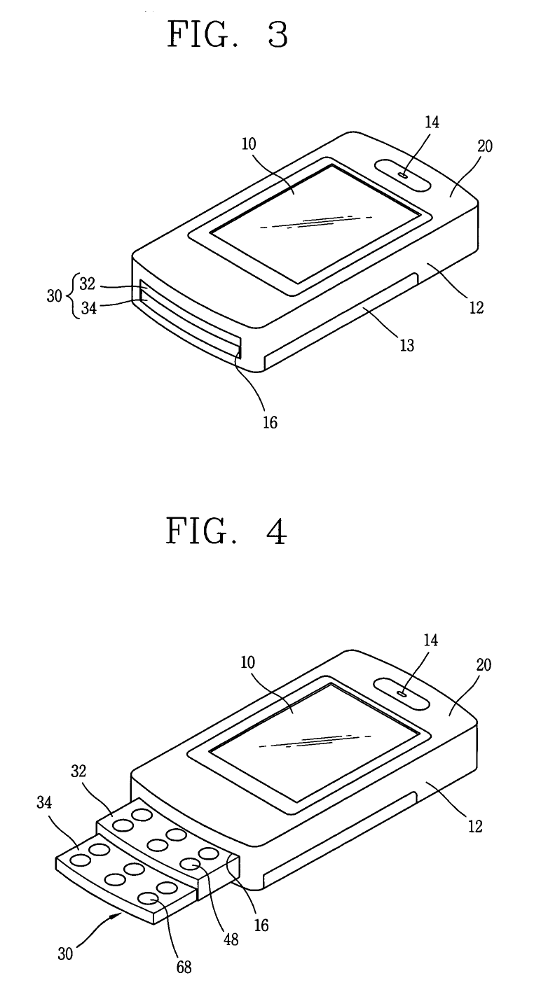

Turning first to FIG. 3, which is an overview of a mobile terminal in accordance with one embodiment of the present invention. As shown, the mobile terminal includes a terminal body 20 having a display 10 mounted on its front surface and a battery 12 mounted on its rear surface. The terminal also includes a stackable keypad assembly 30 slidably received in a receiving part 16 of the terminal body 20 such that the keypad assembly 30 can be drawn out the terminal body 20 when needed.

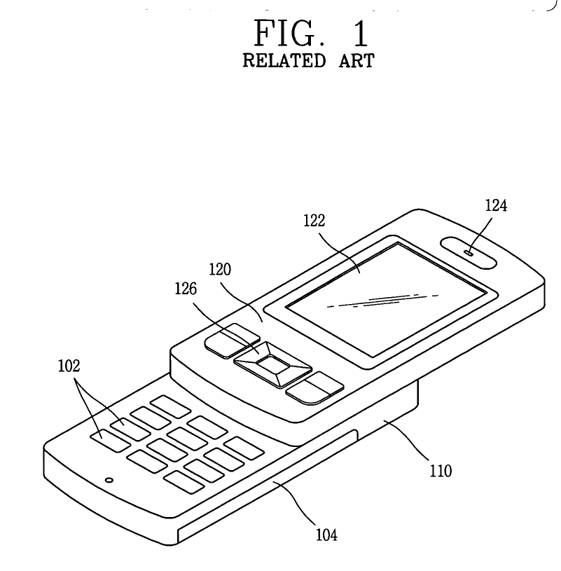

The keypad assembly 30 also includes a first keypad 32 and a second keypad 34. Further, a speaker 14 is mounted at an upper portion on the front surface of the terminal body 20. In addition, FIG. 1 illustrates the receiving part 16 being formed at a lower surface of the terminal body 20. However, the receiving part 16 can also be formed at the left, right or top sides of the terminal body 20.

Next, FIG. 4 is an overview showing an operational state of the mobile terminal in accordance with one embodiment of the present invention. As shown, the first and second keypads 32 and 34 can be drawn out of the receiving part 16 when needed. Note that FIG. 1 illustrates the first and second keypads 32 and 34 being secured within the receiving part 16.

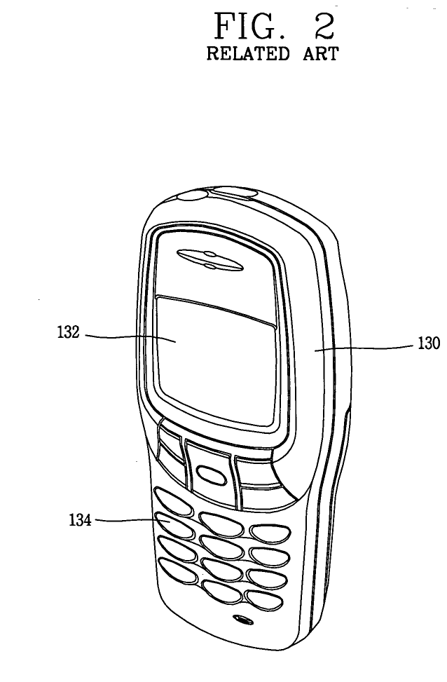

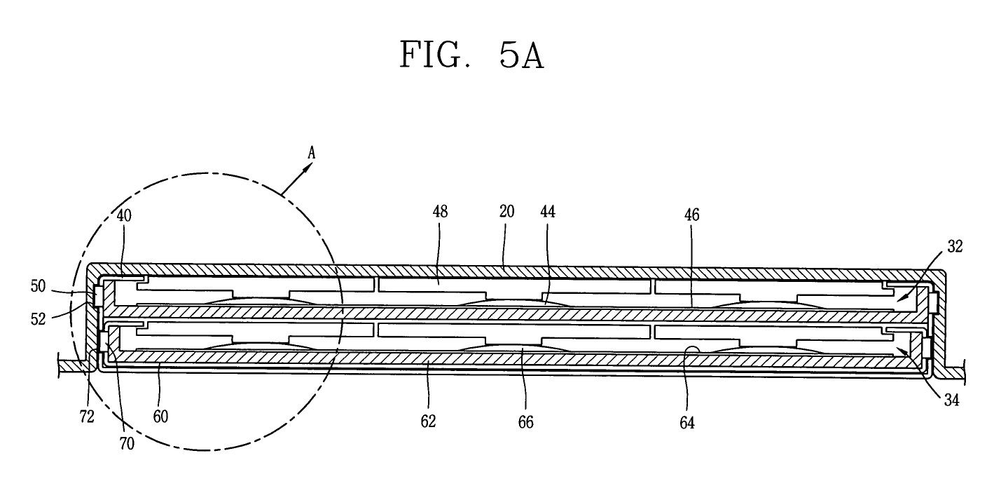

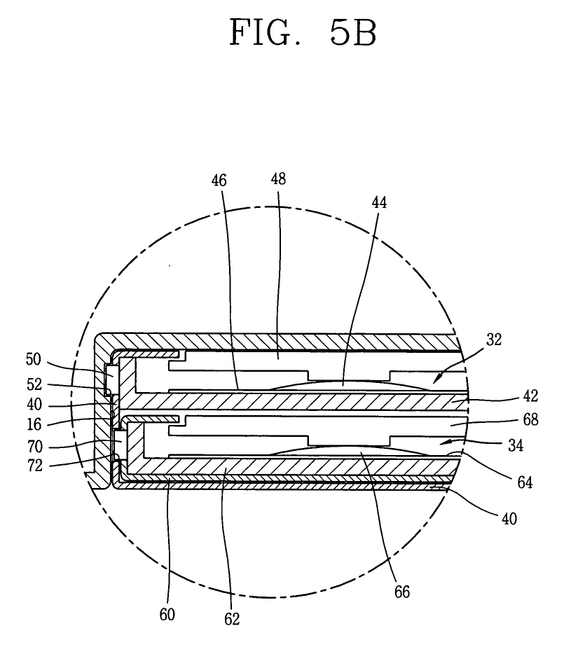

Turning next to FIG. 5A, which is a sectional view of the keypad assembly 30 shown in FIGS. 1 and 2. See also FIG. 5B, which illustrates section “A” of FIG. 5A in more detail. As shown, the second keypad 34 is stacked below the first keypad 32 and slidably mounted with the first keypad 32. Further, the first keypad 32 includes a first frame 40 slidably mounted in the receiving part 16, a first board 42 fixed at the first frame 40, a first PCB 46 mounted at the first board 42 and having a plurality of dome switches 44, and first key buttons 48 disposed on an upper surface of the dome switches 44 and pressing against the dome switches 44.

In addition, the second keypad 34 is slidably received at the first frame 40, the first board 42 is fixed at an upper side of the first frame 40, and both upper ends of the first frame 40 are bent in an inward direction to secure the first key buttons 48. Also, first guide parts including a guide pin 50 and guide slot 52 for slidably guiding the first frame 40 are formed between a side of the first frame 40 and a side of the receiving part 16 of the terminal body 20.

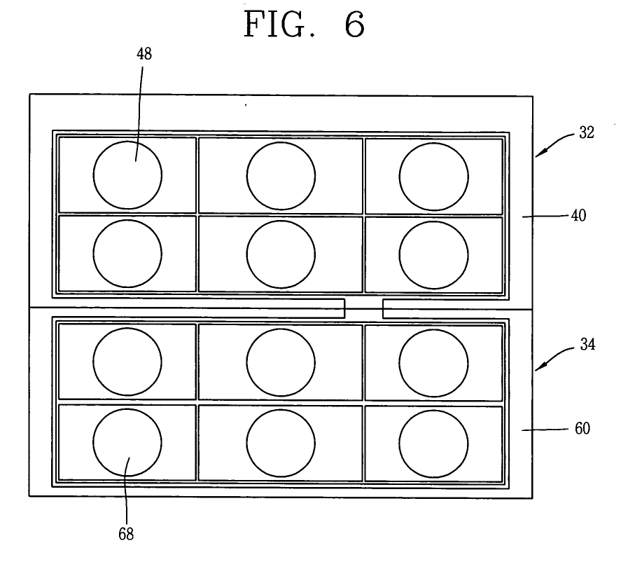

Further, the guide pin 50 is formed to protrude from both sides of the first frame 40, and the guide slot 52 is formed at an inner surface of both sides of the receiving part 16. Thus, the guide pin 50 is inserted and slidably moved in the guide slot 52. In addition, both end portions of the guide slot 52 are blocked to prevent the guide pin 50 from being slidably moved more than a certain distance. Moreover, both edges of the first board 42 extend upwardly and are fixed at both inner sides of the first frame 40, and the first PCB 46 is mounted on an upper surface thereof. As shown in FIG. 6, the key buttons 48 are formed in two lines and are positioned on the upper surface of the first PCB 46.

Further, the second keypad 34 includes a second frame 60 slidably mounted at the first frame 40, a second board 62 fixed at the second frame 60, a second PCB 64 mounted at the second board 62 and having a plurality of dome switches 66, and second key buttons 68 disposed on an upper surface of the dome switches 66 and pressing against the dome switches 66. The second frame 60 is slidably disposed inside the first frame 40 and both upper ends of the second frame 60 are bent in an inward direction to prevent the second key buttons 68 from being released.

Further, second guide parts including a guide pin 70 and guide slot 72 slidably guide a movement of the second frame 60 and are formed between the first and second frames 40 and 60. In addition, the guide slot 72 is formed at both sides of the first frame 40, and the guide pin 70 protrudes from both sides of the second frame 60 and is slidably moved along the guide slot 72. As shown, both edges of the second board 62 extend in an upward direction and are fixed at both inner sides of the second frame 60, and the second PCB 64 is mounted on an upper surface thereof. In addition, it is also possible not to include the first and second key buttons 48 and 68 in which the first and second dome switches 44 and 66 are directly pressed to input information. A touch screen input device may also be used.

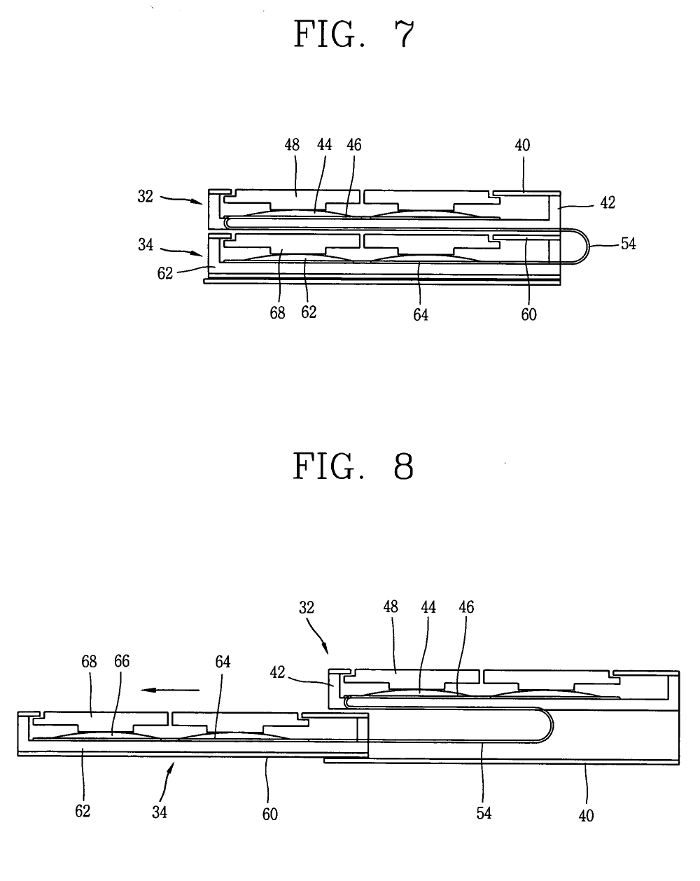

In addition, as shown in FIGS. 7 and 8, a flexible printed circuit (FPC) 54 connects the first PCB 46 and the second PCB 64. That is, one end of the FPC 54 is connected with a front side of the first PCB 46 and the other end is connected with a rear surface of the second PCB 64. Also, the FPC 54 is bent between the first and second keypads 32 and 34. Accordingly, when the second keypad 34 is slidably moved, the bent portion is gracefully moves along with the second keypad 34.

The above-described mobile terminal operates as follows. When a user draws the keypad assembly 30 out of the receiving part 16, the second keypad 34 is slidably drawn out first and then the first key pad 32 follows and is slidably drawn out of the receiving part 16. That is, the second keypad 34 is drawn out as the guide pin 70 of the second frame 60 is slid along the second guide slot 72 formed at the first frame 40, and the first keypad 32 is drawn out as the first guide pin 50 formed at the first frame 40 is slid along the guide slot 52 formed at the receiving part 16.

Accordingly, because the keypad assembly 30 with the first and second keypads 32 and 34 stacked therein is received at the side of the terminal body 20, the display 10 can be installed on the entire front surface or at least a larger front surface of the terminal body 20 than the related art. Thus, the size of the display 10 can be increased and the overall size of the terminal can be reduced.

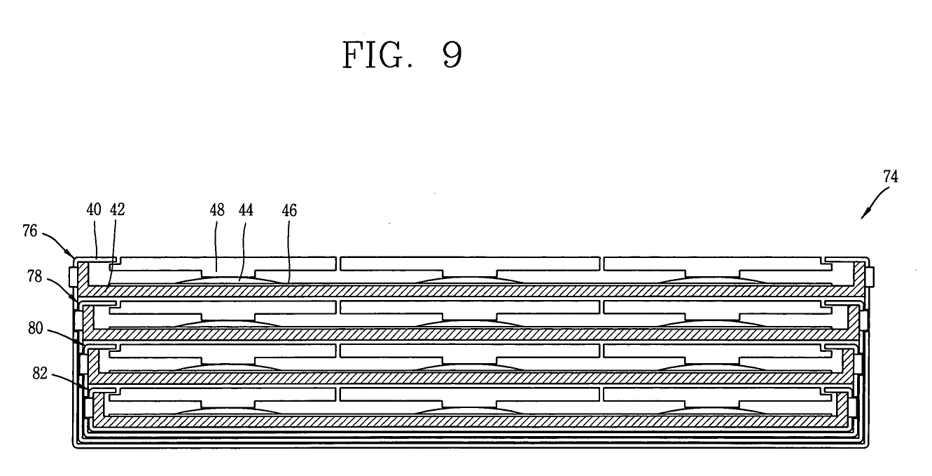

Next, FIG. 9 is a sectional view showing another example of a keypad assembly 74 in accordance with the present invention. In this example, the keypad assembly 74 has four keypads stacked together. Namely, the keypad assembly 74 includes a first keypad 76 disposed at an upper most side, a second keypad 78 slidably connected at a lower surface of the first keypad 76, a third keypad 80 slidably connected at a lower surface of the second keypad 78, and a fourth keypad 82 slidably connected at a lower surface of the third keypad 80. The keypads 76, 78, 80, 82 are stacked in a similar fashion as the keypads 32 and 34. Further, key buttons of the keypads 76, 78, 80 and 82 are arranged in a row. The keypad assembly 74 operates in a similar manner as the keypad assembly 30. It is also possible to provide any number of stacked key pads.

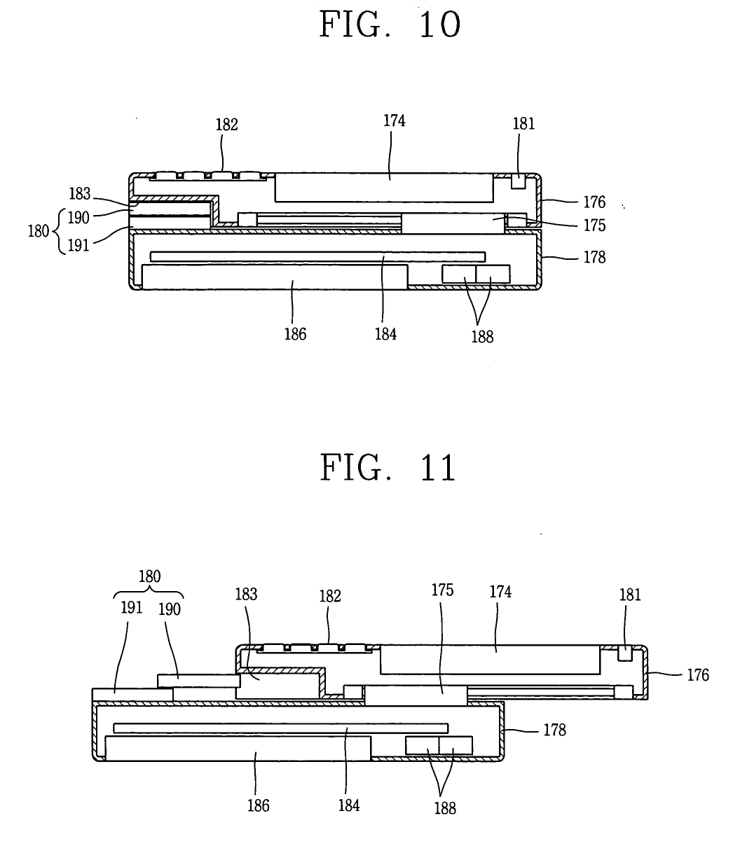

Turning next to FIG. 10, which is a sectional view of a mobile terminal in accordance with another embodiment of the present invention, and FIG. 11, which is an overview showing an operational state of this mobile terminal. As shown, the mobile terminal is a slide type mobile terminal including a first body 76 on which a display 74 is mounted, a second body 78 slidably connected with the first body 76, a slide module 75 mounted between the first body 76 and the second body 78 and slidably guiding the first body 76, and a keypad assembly 80 received in the first body 76. Similar to the other embodiments, the keypad assembly 80 includes stacked keypads 90 and 91 drawn out of the mobile terminal.

In addition, the first body 76 also includes a microphone 81 installed at its upper side, and a multi-keypad 82 installed at its lower side. A receiving part 83 receives the keypad assembly 80 and is formed at a lower side of the portion where the multi-keypad 82 is installed. In addition, because the multi-keypad 82 is thin, a space for accommodating the keypad assembly 80 can be sufficiently secured at its lower side thereof. Further, the receiving part 83 is formed such that the side and lower surface of the first body 76 are opened at the lower side of the multi-keypad 82, and has a space for receiving the keypad assembly 80.

In addition, the second body 78 is slidably moved by the first body 76. The terminal also includes a main PCB 84, and a battery 86 mounted on a rear surface thereof. A space part 88 accommodates another component (e.g., an antenna, ear jack, speaker, etc.) after the battery 86 is mounted. Further, the first keypad 90 is slidably received in the receiving part 83, and the second keypad 91 is slidably stacked on a lower surface of the first keypad 90 and fixed on an upper surface of the second body 78.

In addition, the first and second keypads 90 and 91 are similar to the first and second keypads 32 and 34 in the first embodiment of the present invention, so a detailed description thereof is not repeated. The mobile terminal in accordance with this other embodiment of the present invention operates as follows.

When the first body 76 is slidably moved relatively with respect to the second body 78, the first and second keypads 90 and 91 are drawn out and exposed on the upper surface of the second body 78. Namely, because the second keypad 91 is fixed on the upper surface of the second body 78, when the first body 76 is slidably moved, the second keypad 91 is slidably moved relatively with respect to the first keypad 90 so as to be exposed, and when the movement of the second keypad 91 is completed, the first keypad 90 is slidably moved out of the receiving part 83 and exposed. In addition, when the first body 76 is slidably moved to a closed position, the first keypad 90 is pushed into the receiving part 83 and then the second keypad 91 is pushed into the receiving part 83.

Further, the above description describes both of the first and second key pads being drawn out of the receiving part. However, it is also possible that the user only draw out the first key pad and not draw out the second keypad. The terminal may also be configured such that the second keypad is drawn out without drawing out the first keypad. Therefore, if the user only wants to use one of the keypads, he or she can merely draw out the desired key pad. That is, the first and second key pads may be independently drawn out.

As so far described, the mobile terminal in accordance with the present invention has the following advantages. That is, because the keypad assembly is received within the body of the terminal and can be protracted, the size of the terminal can be reduced. That is, the first and second keypads are slidably mounted with respect to each other such that when the first keypad is drawn out of the body, the first keypad engages with the second keypad to also draw out the second keypad. Thus, the limited space of the terminal is effectively utilized.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A mobile terminal comprising:
a main body having a display mounted thereon; and
a keypad assembly including at least first and second keypads configured to be received in a stacked state within the main body.

2. The mobile terminal of claim 1, wherein the at least first and second keypads are slidably mounted with respect to each other such that when the first keypad is drawn out of the body, the first keypad engages with the second keypad to also draw out the second keypad.

3. The mobile terminal of claim 1, wherein the first or second keypad is independently drawn out of the body.

4. The mobile terminal of claim 1, further comprising:
a receiving part configured to receive the keypad assembly.

5. The mobile terminal of claim 4, wherein the keypad assembly is slidably mounted in the receiving part.

6. The mobile terminal of claim 4, wherein the first keypad comprises:
a first frame slidably mounted at the receiving part;
a first board fixed at the first frame; and
a first printed circuit board mounted at the first board and having a plurality of first dome switches.

7. The mobile terminal of claim 6, wherein the first keypad further comprises:
first key buttons disposed on an upper surface of the first dome switches and configured to be pressed against the first dome switches.

8. The mobile terminal of claim 7, wherein the second keypad is slidably movable in the first frame, the first board is fixed at an upper side of the first frame, and both upper ends of the first frame are bent inwardly to secure the first key buttons.

9. The mobile terminal of claim 6, further comprising:
a first guide portion formed between the first frame and the receiving part and configured to slidably guide the first frame.

10. The mobile terminal of claim 9, wherein the first guide portion comprises a guide pin protruding from both sides of the first frame and a guide slot formed at both inner sides of the receiving part to allow the guide pin to be slidably moved therealong.

11. The mobile terminal of claim 7, wherein the first key buttons are disposed in two rows.

12. The mobile terminal of claim 9, wherein the second keypad comprises:
a second frame slidably mounted at the first frame;
a second board fixed at the second frame; and
a second printed circuit board mounted at the second board and having a plurality of second dome switches.

13. The mobile terminal of claim 12, wherein the second keypad further comprises:
second key buttons disposed on an upper surface of the second dome switches and configured to be pressed against the second dome switches.

14. The mobile terminal of claim 13, wherein the second frame slidably moves inside the first frame and both upper ends thereof are bent inwardly to secure the second key buttons.

15. The mobile terminal of claim 12, further comprising:
a second guide portion formed between the first and second frames and configured to slidably guide the second frame.

16. The mobile terminal of claim 15, wherein the second guide portion comprises a guide slot formed at side of the first frame and a guide pin protruded from a side of the second frame and slidably moved along the guide slot.

17. The mobile terminal of claim 12, further comprising:
a flexible printed circuit connecting the first and second printed circuit boards and being disposed in a folded state between the first and second keypads.

18. The mobile terminal of claim 1, wherein the at least first and second keypads include four keypads slidably moveable with respect to each other.

19. A mobile terminal, comprising:
a first body;
a second body slidably mounted on the first body; and
a key assembly including at least first and second keypads configured to be received in the second body in a stacked state and drawn out when the first body is slidably opened from the second body such that the first and second key pads are exposed on an upper surface of the first body.

20. The mobile terminal of claim 19, wherein the first body comprises:
a display formed on its front surface; and
a receiving part formed at its side into which the keypad assembly is received in the stacked state.

21. The mobile terminal of claim 20, wherein the receiving part is formed at a rear surface of a multi-key pad mounted at a lower portion of the first body.

22. The mobile terminal of claim 19, wherein the second body includes a main printed circuit board mounted therein, a battery mounted on its rear surface, and a component mounted below the printed circuit board in a space next to the battery.

23. The mobile terminal of claim 20, wherein the first keypad is mounted to be slidably moved in the receiving part, and the second keypad is disposed so as to be stacked on the first keypad, slidably connected with the first keypad, and fixed on an upper surface of the second body.

24. The mobile terminal of claim 20, wherein the first keypad comprises:
a first frame mounted to be slidably moved in the receiving part;
a first board fixed at the first frame; and
a first printed circuit board mounted at the first board and having a plurality of first dome switches.

25. The mobile terminal of claim 24, wherein the first keypad further comprises:
first key buttons disposed on an upper surface of the dome switches and configured to be pressed against the first dome switches.

26. The mobile terminal of claim 25, wherein the second keypad slidably moves in the first frame, and both upper ends of the first frame are formed to be bent inwardly to secure the first key buttons.

27. The mobile terminal of claim 24, further comprising:
a first guide portion for guiding the first frame to be slidably movable formed between the first frame and the receiving part,
wherein the first guide portion comprises a guide pin protruding from both sides of the first frame and a guide slot formed at both inner sides of the receiving part to allow the guide pin to be inserted and slidably moved therealong.

28. The mobile terminal of claim 27, wherein the second keypad comprises:
a second frame slidably mounted at the first frame;
a second board fixed at the second frame; and
a second printed circuit board mounted at the second board and having a plurality of second dome switches.

29. The mobile terminal of claim 28, wherein the second keypad further comprises:
second key buttons disposed on an upper surface of the second dome switches and configured to be pressed against the second dome switches.

30. The mobile terminal of claim 29, wherein the second frame slidably moves inside the first frame and both upper ends thereof are bent inwardly to secure the second key buttons.

31. The mobile terminal of claim 28, further comprising:
a second guide portion formed between the first and second frames and configured to slidably guide the second frame; and
a flexible printed circuit connecting the first and second printed circuit boards and being disposed in a folded state between the first and second keypads,
wherein the second guide portion comprises a guide slot formed at side of the first frame and a guide pin protruded from side of the second frame and slidably moved along the guide slot.

32. A mobile terminal, comprising:
a first body;
a second body slidably mounted on the first body; and
a keypad assembly including at least first and second keypads configured to be received between the first and the second body in a stacked state and the first keypad is connected to the first body and the second keypad is connected to the second body such that when the first body is slid open from the second body, the first and second keypads are protracted.
